(19) United States
(12) Patent Application Publication
(10) Pub. No.: US 2012/0136466 A1
(43) Pub. Date: May 31, 2012

(54) SYSTEM AND METHOD FOR IDENTIFYING A BROADCAST SOURCE OF AMBIENT AUDIO

(76) Inventor: Aron WEISS, Ramat Hasharon (IL)

(21) Appl. No.: 13/304,821

(22) Filed: Nov. 28, 2011

Related U.S. Application Data
(60) Provisional application No. 61/417,430, filed on Nov. 28, 2010.

(51) Int. Cl. G06F 17/00

(52) U.S. Cl. 700/94

(57) ABSTRACT

A method and system for identifying a source of broadcast audio based on an identification of a sequence of audio clips that are collected in an ambient audio. An audio clip in the ambient audio is identified by comparing characteristics of the ambient audio with characteristics of known or pre-defined broadcast audio clips such as jingles or advertisements that are known to be broadcast by a broadcaster. A recognized clip is associated with a time of its broadcast or collection. A digital representation of a sequence of recognized audio clips collected at time is compared to audio clips that were broadcast by various broadcasters at such time. A match of the clips may be deemed an indication that the broadcaster was listened to at such time.

### CROSS REFERENCE TO RELATED APPLICATION

This application claims the benefit of U.S. Provisional Application No. 61/417,430, filed on Nov. 28, 2010 entitled “Method of Probabilistically Identifying the Time and Source of Broadcast Material”, incorporated by reference herein in its entirety.

### FIELD OF THE INVENTION

The present invention relates to identifying a source of broadcasted material that is received as audio content.

### BACKGROUND OF THE INVENTION

The numerous devices over which users consume broadcasted audio and video content has increased the complexity of collecting consumer consumption data of such content. In the past television or broadcast content may have been viewed on a single set in a living room where viewing habits could be monitored by a device installed on the single set. Such rating systems are subject to reduced accuracy in light of the portability of devices that receive broadcast content, the availability of broadcast content on the Internet, and numerous other changes in content consumption habits.

### SUMMARY OF THE INVENTION

Embodiments of the invention may include a method for identifying a source of broadcast audio, where the method includes identifying a sequence of pre-defined audio clips that may be heard, broadcast or played in ambient audio, for example audio playing or audible in a space, which may be captured by, for example, microphones. The identified sequence may be associated with a time that one or more of the audio clips were collected. The identified clips or the sequence may be compared to a sequence of audio clips that was broadcast by a broadcast source that is the same or similar to the times that were associated with the collected and identified clips.

In some embodiments, characteristics or digital representations of the clips may be transmitted to and stored in for example a mobile device that may also include a microphone, such that the microphone may collect the ambient audio, and the comparison of the collected audio to the stored characteristics may be performed by a processor associated with the mobile device.

In some embodiments the sequence of identified clips may be compared to various audio clips or indications of audio clips that were broadcast by various broadcasters at the time that was associated with the clips.

In some embodiments, a frequency of the broadcast of audio clips by broadcasters may be determined for one or more of such clips, and the pre-defined clips about which an indication is to be saved may be determined from such frequency so that frequently broadcast clips are included in the clips stored on a device for later comparison.

In some embodiments, a probability may be calculated that a source of an identified sequence is the same as a sequence of audio clips broadcast by a particular broadcaster.

In some embodiments a method may include identifying two or more sequences of audio clips that are collected in an ambient audio, comparing a time lapse between the two or more sequences, determining that both sequences are attributed to the same broadcaster, and associating a mobile device that collected the two sequences with a broadcaster for the period of such time lapse.

Some embodiments may include storing a characteristic of many audio clips that are associated with a particular broadcaster.

Some embodiments may include storing a frequency of a broadcast of various audio clips during a period, and estimating a period that a mobile device was in an ambient audio where the broadcasted clips were heard. Such estimate may be part of an estimation of a period that the broadcast was heard or played in the ambient audio.

Embodiments of the invention may include a system for identifying broadcast audio content, where the system includes a processor to accept an indication of a sequence of audio clips. The indications may be used in a comparison of pre-defined audio clips to audio clips collected in an ambient audio. The processor may also accept a time associated with an audio clip in the sequence of audio clips and compare the sequence of audio clips to an indication of audio clips that were broadcast during the particular time.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1A conceptually illustrates an audio stream and a broadcast audio profile according to an embodiment of the invention;

FIG. 1B conceptually illustrates different time domains applicable to an embodiment of the invention;

FIG. 2 conceptually illustrates components of a broadcast stream database utilizing broadcast audio profiles according to an embodiment of the invention;

FIG. 3 conceptually illustrates components of a broadcast statistics server according to an embodiment of the present invention;

FIG. 4 conceptually illustrates components of an audio stream monitor device according to an embodiment of the invention;

FIG. 5 illustrates a conceptual summary of a data interchange among components of a system for determining broadcast source statistics according to an embodiment of the present invention;

FIG. 6 conceptually illustrates a broadcast source report histogram according to an embodiment of the present invention;

FIG. 7 is a flow diagram of a method in accordance with an embodiment of the invention; and

FIG. 8 is a flow diagram of a method in accordance with an embodiment of the invention.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification, discussions utilizing terms such as “switching”, “comparing”, “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

An embodiment of the invention may be practiced through the execution of instructions such as software that may be stored on an article such as a disc, memory device or other mass data storage article. Such instructions may be for example loaded into a processor and executed on one or more computerized platforms. It will also be appreciated that while embodiments of the current invention are primarily described in the form of methods, systems and devices, the invention may also be embodied, at least in part, in a computer program product as well as a system comprising a computer processor and a memory coupled to the processor, wherein the memory is encoded with one or more programs that may perform the functions disclosed herein.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

When used herein, “instruction” may include for example, a set of machine-readable instructions (e.g., software) which, when executed by a processor, cause the processor to take certain actions. Instruction may also mean an instruction to cause processor to execute certain routines, or send certain signals (e.g., signals to an output device).

In addition to its regular meaning, the terms “broadcaster”, “broadcast source” and “source” with reference to broadcast of media content may in addition to their regular meaning also refer to a specific broadcast instance of the particular material such as an audio clip that was received, including the identification of the broadcaster, and/or other identifying information, such as a playlist. The term broadcast herein denotes the dissemination of information or media content to a multiplicity of prospective receivers thereof, via the emanation of a time-parameterized sequence of information and/or media content. The term broadcaster or broadcast source herein denotes any entity that makes audio media available to the public or to a subscriber base over broadcast means including, but not limited to: radio; television; cable; satellite; telephony networks without limitation, including public and private telephone systems, PBX, land-line and mobile (e.g., cellular) telephone networks; closed-circuit systems; local area and wide-area networks such as the Internet. The term “identification of the broadcaster” herein denotes any information which uniquely specifies the broadcaster, including, but not limited to station name; call-letters; broadcast frequency; channel; URL; IP address, or alias thereof; telephone number, or similar identifier. The term “time” or “time of broadcast” herein denotes the actual time the material such as an audio clip was broadcast by the broadcaster and suitable for collection in by ambient audio collector such as a microphone.

In addition to its regular meaning, the term “audio clip” may in addition to its regular meaning also refer to a portion or segment of an audio stream having a defined start position and a defined end position. Broadcast audio clips may be bounded by silence within the audio stream to separate the audio clips. Non-limiting examples of audio clips include: a track of music; a jingle; a commercial advertisement; a news story or bulletin; etc. The term “audio clip” or “media clip” herein denotes an audio-video stream encompassing or transmitted either along or simultaneously with a video stream with which the audio clip is associated. In some embodiments, an audio clip may be or include an audible part of a transmission of a video. In some embodiments, a segment or audio clip does not necessarily contain a complete audio clip, nor is a segment necessarily restricted to a single clip, but may overlap different clips.

In addition to its regular meaning, the term ‘ambient audio’ may refer to audible sounds representing broadcast or transmitted audio or audio and video signals that may have been reproduced by for a example a speaker or other sound production device, where such audio or sounds may be collected or heard by for example a microphone or other sound recording device. While the range of an ambient audio may vary depending on the microphone and on the pitch or volume of the audio, a range of several feet to several tens of meters may be readily achievable from a microphone of any of a cell-phone, table computer, laptop or other mobile electronic devices. Such devices may include for example a microphone as well as a processor, memory and input/output units.

In addition to its regular meaning, the term “broadcast” may also denote transmission to a small audience or target group. For example, broadcast may include streaming of audio or sound to a group of listeners or users.

It is understood that the components of the preferred embodiments of the present invention are presented conceptually as logical entities and may be physically implemented in various different configurations (hardware, software, networked, etc.) having the essential functionality as herein presented. Therefore, the configurations described and illustrated herein are for exemplary purposes and are not intended to limit the scope of the present invention.

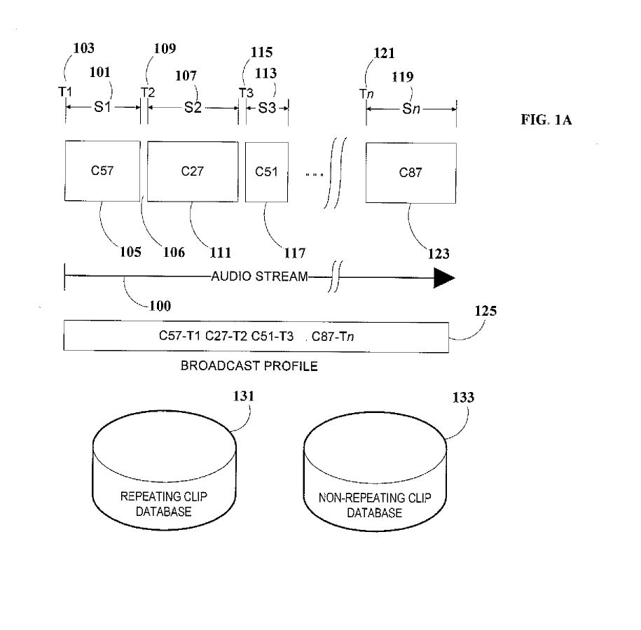

FIG. 1A conceptually illustrates a non-limiting example of an audio stream 100 having a broadcast audio profile 125 according to embodiments of the present invention.

Audio profiles according to embodiments of the present invention may be based on the principle that, as a result of broadcast scheduling demands and considerations, the selection of short clips for broadcasting, and the particular order thereof typically vary in a material way from one broadcast instance to another. Thus, a sufficiently inclusive broadcast audio stream has a clip arrangement which is statistically distinct from other broadcast clips. Accordingly, broadcast audio profile may be represented as a linear series of clip identifiers (“clip ID's”), each of which is associated with a sequential time during which the audio clip may have been broadcast. In conjunction with this scheme, a repeating clip database 131 may include or contain clip ID's for clips which are repeatedly, occasionally or frequently broadcast by one or more broadcasters. A non-repeating clip database 133 may include or contain clip ID's for audio clips which may be broadcast only once by one particular broadcaster. In an embodiment of the present invention, repeating clip database 131 and non-repeating clip database 133 may be stored in separate databases. In another embodiment of the present invention, repeating clip database 131 and non-repeating clip database 133 may be combined into a single database. In further embodiments of the invention, operational differences between a repeating clip and a non-repeating clip include, but are not limited to, for example: data for repeating clips may be typically retained for a longer time than for non-repeating clips; and a data record for a non-repeating clip may contain information about the broadcast source and broadcast time of the non-repeating clip by one or more broadcaster, whereas data for a repeating clip may not contain such information (because a repeating clip may not be specific to any broadcast source or broadcast time).

It is noted that an audio clips may be deemed to be the units of a sequence of audio clips, such that a sequence of audio clips may include one or more clips that are broadcast during a given period of time where each audio clip may be represented by for example digital data according to embodiments of the present invention.

A clip S1 101 starting at a time T1 103 is identified in this non-limiting example as a clip 105 having a clip ID C57 or other digital representation. After a short time delay 106, this is followed by a clip S2 107 starting at a time T2 109 which is identified in this non-limiting example as a clip 111 having a clip ID C27. This is followed by a clip S3 113 starting at a time T3 115 which is identified in this non-limiting example as a clip 117 having a clip ID C51, and eventually terminating in a clip Sn 119 starting at a time Tn 121 which is identified in this non-limiting example as a clip 123 having a clip ID C87.

Broadcast audio profile 125 is thus C57-T1 C27-T2 C51-T3 . . . C87-Tn. This is a compact data representation of broadcast audio stream 100. The example profile essentially requires only enough data to contain the unique clip ID's and the timestamps for the start-times of the clips. Other profiles may include different data.

In one embodiment of the present invention, clip ID's are unique (or unique within the system) and are arbitrarily assigned. In another embodiment, the timestamps have a limited resolution comparable to the timing accuracy of broadcast scheduling.

### Broadcast Audio Profile Time Domains

It is noted that there may be different time domains applicable to audio profiles according to the present invention. This aspect pertains may pertain to components of the audio profiles. Time can be expressed in local time or other mutually agreeable convention, including, but not limited to Universal Time Coordinates (UTC).

FIG. 1B conceptually illustrates examples of the different time domains. For a broadcast source 151, the time domain of interest may include a broadcast time 153. This is the actual time when a particular audio stream or sequence of clips is broadcast. For a reception by a receiver 155 (having an audio output 156), the time domain of interest is a reception time 157. This is the actual time when a particular audio stream is received and may enter or input an ambient audio from a loudspeaker. The term “received broadcast” herein may denote the broadcast as received or collected in an ambient audio by a receiving device. Typically, for a particular broadcast audio stream, transmission delays (e.g., via signal propagation, network processing, processing at a playback device such as a radio or computer) can generally be ignored, in which case reception time 157 is substantially the same as broadcast time 153 (allowing for conversions between local times as appropriate, if broadcast source 151 and receiver 155 are in different time zones and if local time is used). Such transmission delays are typically different from delays in playback from time-shifted broadcasts, e.g., playing a downloaded podcast some time after it is recorded or originally broadcast.

In some cases, receiver 155 may be equipped with, or connected to, a recording device/recording medium 159 for time-shifted playback of the received broadcast at a later time. Subsequently recording device/recording medium 159 may be played back into a playback device 161 (having an audio output 162), wherein the time domain of interest is a playback time 163. It is noted that playback device 161 may physically be the same device as receiver 155 being operated in a playback rather than in a receiving mode. The terms “playback of received broadcast” and “played-back received broadcast” herein denote the broadcast as played back from a recording of a received broadcast. Collective devices may include microphones or other audio detectors or sensors. Recording devices include, but are not limited to: video recording devices utilizing magnetic tape, optical disk, flash memory or other semiconductor storage; audio recording devices utilizing magnetic tape, optical disk, flash memory or other semiconductor storage; computer or data storage devices; and network storage devices accessible via a network, such as the Internet.

In an embodiment of the present invention, broadcast source 151 is monitored by a broadcast source monitor 171, which may receives a substantially continuous audio stream input from broadcast source 151, as discussed below.

In cases of remote monitoring, when a remote monitor device 165 monitors audio content, the time domain of interest is a monitor time 167, which may be the same as reception time 157 or playback time 163, depending on whether a received broadcast or a played-back received broadcast is being monitored. The terms “remote monitoring”, “remote monitor device”, and the like denote a device which may be located at a point of reception of broadcast material or playback of received broadcast material which has been previously recorded, and which monitors the received or played-back audio stream.

Remote monitor 165 typically has no way of knowing a priori whether the audio stream being monitored is being presently received or is being played back from a previous reception that was recorded during reception (e.g., “time-shifted”). Systems and methods according to embodiments of the present invention, may treat all monitored audio streams in the same fashion; systems and methods according to embodiments of the present invention may identify a time of the original broadcast, and if the identified time is the current time, it will be apparent that the monitored audio stream is being received directly from a received broadcast rather than from a playback of a received broadcast.

Remote monitor device 165 is also discussed in further detail below.

The Actual Broadcast Time Domain: In this domain the audio profile times T1, T2, etc., are broadcast time 153 of the audio clips, as determined by.

The Received Broadcast Time Domain: In this domain the audio profile times T1, T2, etc., are reception time 157 of the audio clips.

The Played-back (“Time-Shifted”) Received Broadcast Time Domain: In this domain the audio profile times T1, T2, etc., are playback time 163 of the audio clips.

The Monitored Received Broadcast Time Domain: In this domain the audio profile times T1, T2, etc., are monitor time 167 as determined by remote monitor device 165. Monitor time 167 corresponds to reception time 157 or to playback time 163 as described herein, but it may not be possible to immediately determine which. In either case, remote monitor device 165 monitors an audio stream corresponding to a received broadcast, and samples audio segments from the corresponding received broadcast. As noted, it is an objective of one embodiment the present invention to determine, from an audio stream received at a remote monitoring device, the broadcast time and source of the original broadcast, e.g., to determine broadcast source 151, and whether monitor time 167 corresponds to reception time 157 or to playback time 163, and in the case of playback, to determine broadcast time 153.

The (“time-shifted”) playback time domain values (of T1, T2, etc.) differ materially from the actual broadcast time domain values. In addition, minor time discrepancies are normally expected, so that a received broadcast audio profile may differ from an actual broadcast audio profile in terms of the absolute time measurements of T1, T2, etc. For this reason, an embodiment of the present invention provides for relative time audio profiles, wherein T1 is taken as a relative time point and assigned the value 0 (zero). In this embodiment, T2, T3, etc., are taken as relative to T1.

Unless otherwise specified as a “received broadcast” or as a “played-back received broadcast”, the term “broadcast” herein denotes actual broadcast, as discussed above.

### Broadcast Stream Database

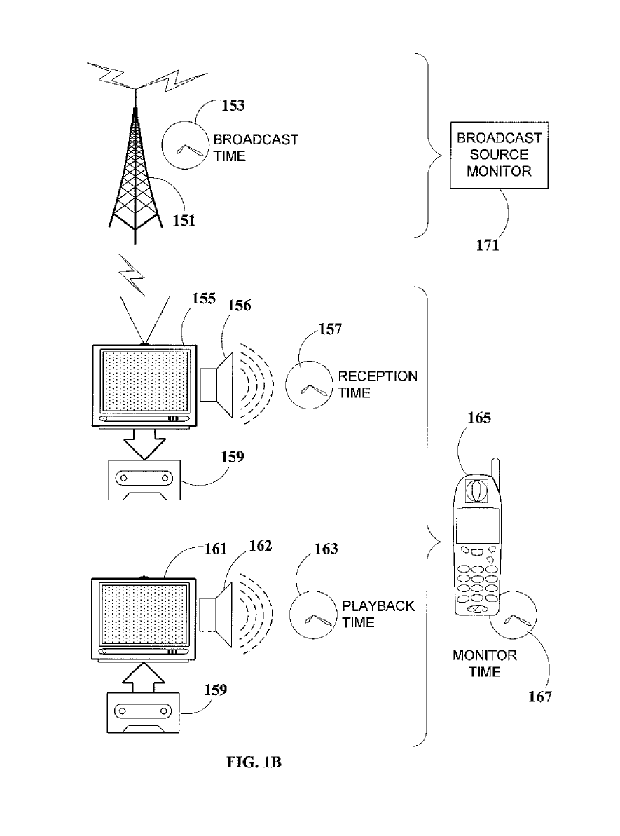

FIG. 2 conceptually illustrates components of a broadcast stream audio profile database 201 utilizing broadcast audio profiles according to an embodiment of the present invention, such as illustrated in FIG. 1A and as described above.

Three broadcast audio sources are illustrated in the non-limiting configuration shown in FIG. 2: a source A 203; a source B 205, and a source C 207, which are input via a broadcast source monitor 208 into audio profile generators 209, 211, and 213, respectively. In an embodiment of the present invention, broadcast source monitor 208 is a multi-channel monitor capable of monitoring several channels simultaneously. In another embodiment of the present invention, separate broadcast source monitors are used individually for different sources. In a further embodiment of the present invention, a single audio profile generator, such as audio profile generator 209, is shared among all sources. The illustration in FIG. 2 of a configuration for three sources is non-limiting; different numbers of different sources are also possible.

In an embodiment of the present invention, components to implement and support database 201 are contained within a broadcast stream database server 223, which has a link 229 to a network 225, such as the Internet.

To generate audio profiles according to the present invention, a clock such as a real-time clock 217 may be used; and, as described below, there may be sources of clip ID's for received audio segments which are extracted from the input sources.

In an embodiment of the present invention, a local repeating clip database 227 provides clip ID's for repeating clips (such as commercial advertisements), which can be expected to be received from time to time in broadcasts. In an embodiment of the present invention, an external clip identification server 215 provides a clip ID 221 for an audio segment 219 extracted from a source (such as source A 203).

Audio profiles output by one or more audio profile generators 209, 211, and 213 constitute broadcast stream audio profile data 231, which may be fed into broadcast stream audio profile database 201.

In an embodiment of the present invention, an external database updater 233 synchronizes external databases to be compatible with the information in broadcast stream audio profile database 201. External databases include databases in remote audio stream monitor devices, as detailed below.

### Broadcast Statistics Server

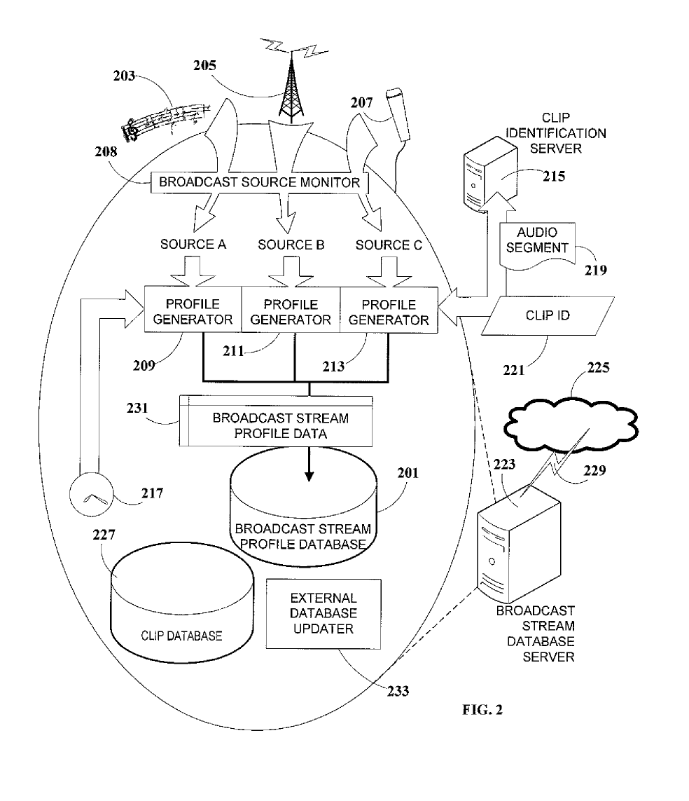

FIG. 3 conceptually illustrates components of a broadcast statistics server 301 according to an embodiment of the present invention. Broadcast statistics server 301 may perform functions including, but not limited to, for example: Input and analysis of broadcast data extracted from broadcast sources, such as by broadcast stream database server 223 (such as via network 225); input and analysis of received broadcast data as sampled and collected by remote monitoring devices and other apparatus, such as monitor device 165, via a remote audio stream monitor input 305; correlating of audio profiles of received broadcast audio collected by remote monitoring devices with audio profiles from actual broadcast audio, via an audio profile correlator 307; statistical analysis of the set of audio profiles and the times of broadcast, reception, and monitoring thereof, via a statistical analyzer 309; handling queries for statistical and other information, via a query handler 311; generating reports summarizing desired broadcast statistics, via a report generator 313; and storing received audio broadcast profiles and/or played-back audio broadcast profiles in a received/played-back broadcast profile database 315.

In embodiments of the invention, broadcast statistics server 301 may also contain database interface 317, for interfacing with external databases.

In embodiments of the invention, broadcast statistics server 301 communicates via network 225 with other facilities, for example broadcast source 151 and remote monitor device 165.

### Remote Audio Stream Monitor

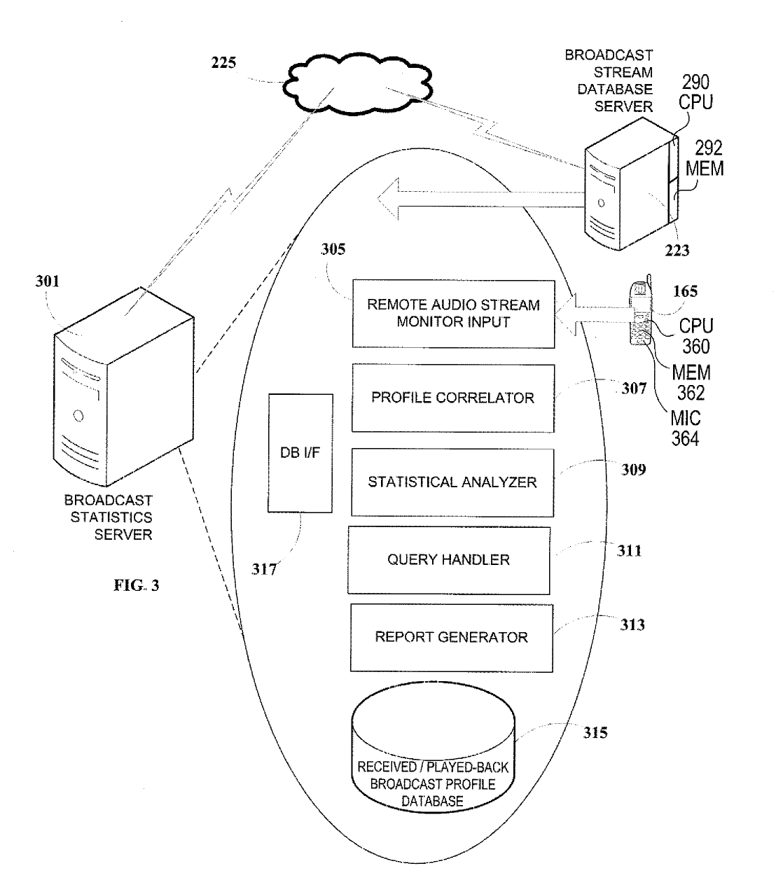

FIG. 4 conceptually illustrates components of a remote audio stream monitor 165 according to embodiments of the present invention.

In embodiments of the invention, remote audio stream monitor 165 may be a General Packet Radio Service (GPRS) device hosting an application which periodically records audio samples from an audio stream 403 via a microphone 405. Monitor 165 may also include a processor 360 and a memory 362.

Actions performed by remote audio stream monitor 165 include, for example: comparing the audio samples with samples in a local clip database 407 containing repeating audio clips (including, but not limited to clips such as: commercial advertisements; announcements; and music tracks); generating an audio profile of audio stream 403 using an audio profile generator 409; storing generated audio profiles in local storage, such as an audio profile database 415; and forwarding audio profile data to broadcast statistics server 301 for storage in received/played-back broadcast audio profile database 315 (FIG. 3).

In an embodiment of the invention, a clip ID for audio profile generator 413 may be provided by clip identification server 215 in conjunction with broadcast stream database server 223 over network 225. A clock 411 provides timestamp information for audio profile generator 413. Non-limiting implementations of clock 411 include: a local clock within remote audio stream monitor 165; and a time-signal source via a cellular network or other network.

FIG. 4 also illustrates a configuration according to an embodiment of the invention, whereby broadcast stream database server 223 receives source input from broadcast source 151 through broadcast source monitor 171 via network 225. Server 223 may include a processor 290 and a memory 292. In some embodiments, server 223 may accept an indication of a first sequence of audio clips as was collected by for example a microphone 364 of monitor 165 from audio such as for example an ambient audio. The indication may represent a sequence of one or more audio clips that were heard by microphone 364, and that were converted to a digital representation or indication of the audio clips in the ambient audio. Processor 360 may compare indications of audio clips that were collected from ambient audio to indications of pre-defined audio clips that are stored in memory 362. Processor 360 may associate a time, such as a time of day, with one or more of the representations of audio clips in the collected sequence. Processor 290 may compare the sequence of audio clips that were collected in memory 362 to a collection of sequences of audio clips that may be stored in memory 292 that represent sequences of audio clips that were broadcast during the time that was associated by processor 360.

### Data Interactions

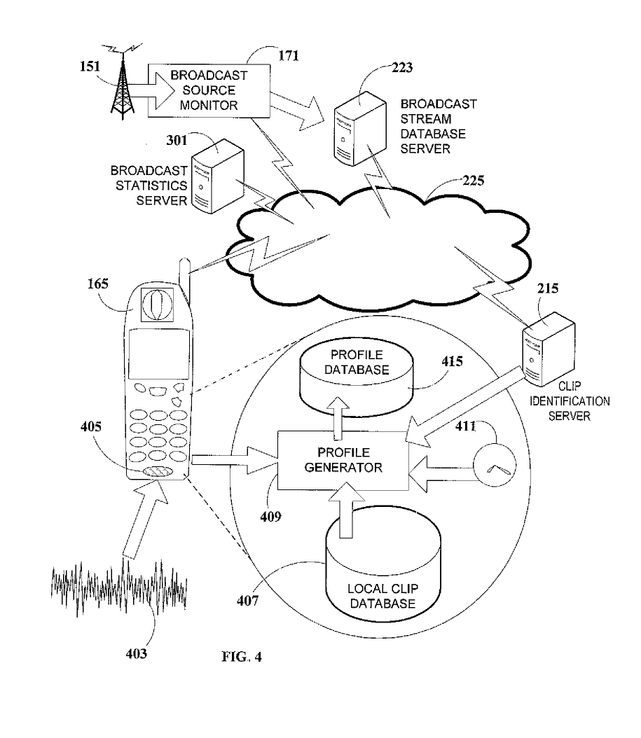

FIG. 5 illustrates a data interchange among the components of a system for determining broadcast source statistics according to an embodiment of the invention. In an embodiment, components include remote audio stream monitor 165, clip identification server 215, broadcast stream database server 223, and broadcast statistics server 301. Data interchange may be facilitated by connections to network 225. After inputting an audio of an audio stream (FIG. 4), remote monitor 165 sends audio segment 219 to clip identification server 215, after which clip ID 221 is returned from clip identification server 215 back to remote monitor 165. Broadcast stream database server 223 is also able to send audio segment 219 to clip identification server 215 and receive clip ID 221. For an audio segment 220 which is not recognized by clip identification server 215 (for example, in case audio segment 220 does not contain a repeating audio clip), remote audio stream monitor 165 sends audio segment 220 broadcast stream database server 223 for identification, and receives a clip ID 222 in return. Subsequently, remote monitor 165 employs clip ID 221 and clip ID 220 to construct received/played-back broadcast profile 125, which is sent to broadcast statistics server 301 for profile correlation, statistical analysis, and report generation (FIG. 3).

### Reports and Report Generating

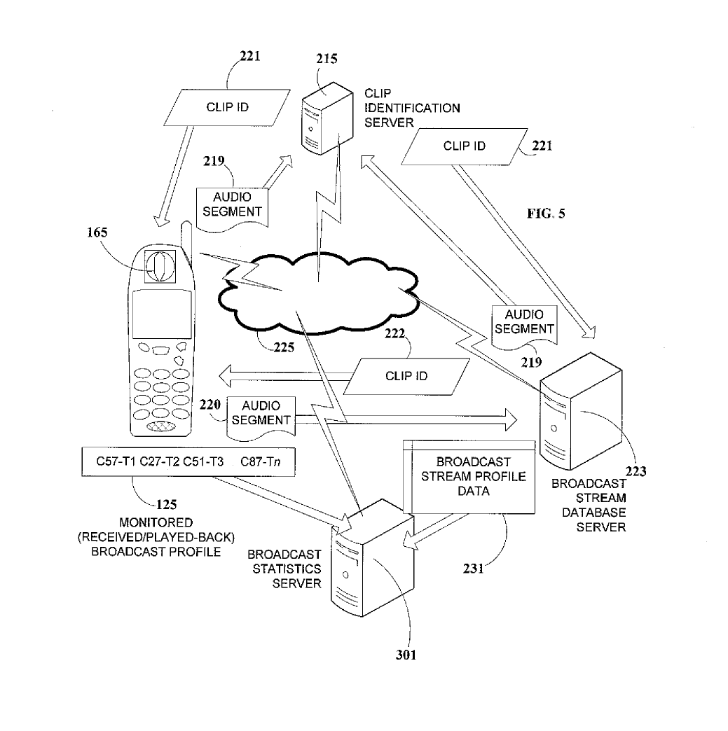

FIG. 6 illustrates an example of a report histogram generated according to an embodiment of the invention. Along a broadcast source axis 603 and plotted according to a number of receptions axis 601 as a function of time of broadcast 605 is a histogram 607 for a broadcast source A, a histogram 609 for a broadcast source B, and a histogram 611 for a broadcast source C. In FIG. 6, time axis 605 is selected to be actual broadcast time 153 (FIG. 1B). However, in an embodiment of the present invention, the time axis can be selected as monitor time 167, from which can be derived statistics of reception time 157 and playback time 163. Other or different information may be included in a histogram. In addition, other report formats, both printed and graphical, are possible.

An embodiment of the present invention allows compiling statistics which include time-shifted playback of received broadcasts as well as broadcasts received in real time.

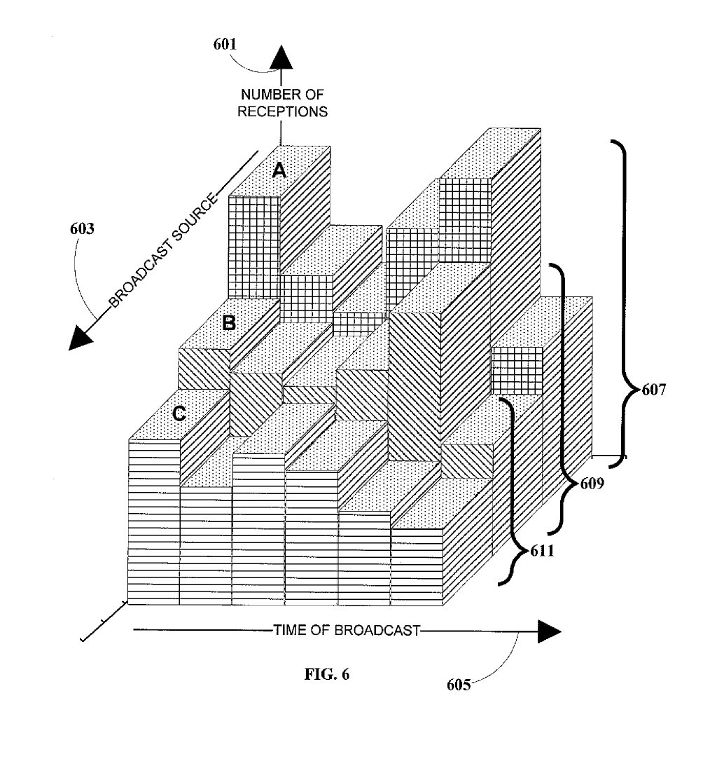

Reference is made to FIG. 7, a flow diagram of a method in accordance with an embodiment of the invention. Embodiments of the invention may include a method for identifying a source of broadcast audio. The method may include, as is shown in block 700, identifying a sequence of pre-defined audio clips that may have been collected, detected or otherwise heard or received by for example a microphone or other electro-mechanical listening device, for example in an ambient audio, from sounds that were played in an area of the listening device. In block 702, a processor may associate a time that one or more of the sequence of audio clips was collected or heard. In block 704, a processor may compare the identified sequence of audio clips to one or more sequences of audio clips that were broadcast by one or more broadcasters during the time that was associated with the sequence of audio clips that was collected.

In some embodiments, one or more characteristics of one or more audio clips may be stored in for example a memory of a mobile device that may include processor, a memory and a microphone that may be suitable to collect ambient audio, and the stored characteristics may be compared with a characteristic of the collected ambient audio.

In some embodiments, a digital representation of the identified sequence of audio clips may be transmitted to a processor that may be associated with a memory that may store sequences of audio clips that were broadcast by several broadcasters during the time that was associated with the collected clips.

In some embodiments, an estimate or ranking may be made of a frequency with which one or more audio clips is broadcast by one or more broadcasters, and a selection of audio clips that may be transmitted to a memory on a mobile device may be made based on a ranking of a frequency with which the audio clip may be broadcast. For example, a jingle of a radio station may be broadcast every few minutes by a station, where a commercial may be broadcast once or twice a day. The jingle may therefore be selected for transmission and storage on a mobile device, and the commercial may or may not be selected.

In some embodiments, a digital representation of the identified sequence of audio clips may be generated by for example a processor associated with the mobile device that collected the clips, and such digital representation may be transmitted to facilitate the comparison to sequences of audio clips broadcast by broadcasters at the relevant time during which the clips were collected.

In some embodiments, a method may include determining a probability that a source of the identified sequence as was collected from an ambient audio is the same as a sequence of audio clips broadcast by a broadcaster.

In some embodiments, two or more sequences of audio clips may be detected and stored or transmitted to a processor, where each of such sequences is associated with a time during which one or more the audio clips in the sequence was detected or identified. The sequences may be compared to sequences that were broadcast during the relevant associated times, and a broadcaster may be identified as having broadcast such sequence of clips during such times. A mobile device or other device that may have collected the clips may be associated with the broadcaster that broadcast such clips, and such association may include the time period between the time of the first identified clip and the time of second identified clip. Such association may indicate that the mobile device was in an area of ambient audio where the relevant broadcast of the broadcaster was heard for such time period.

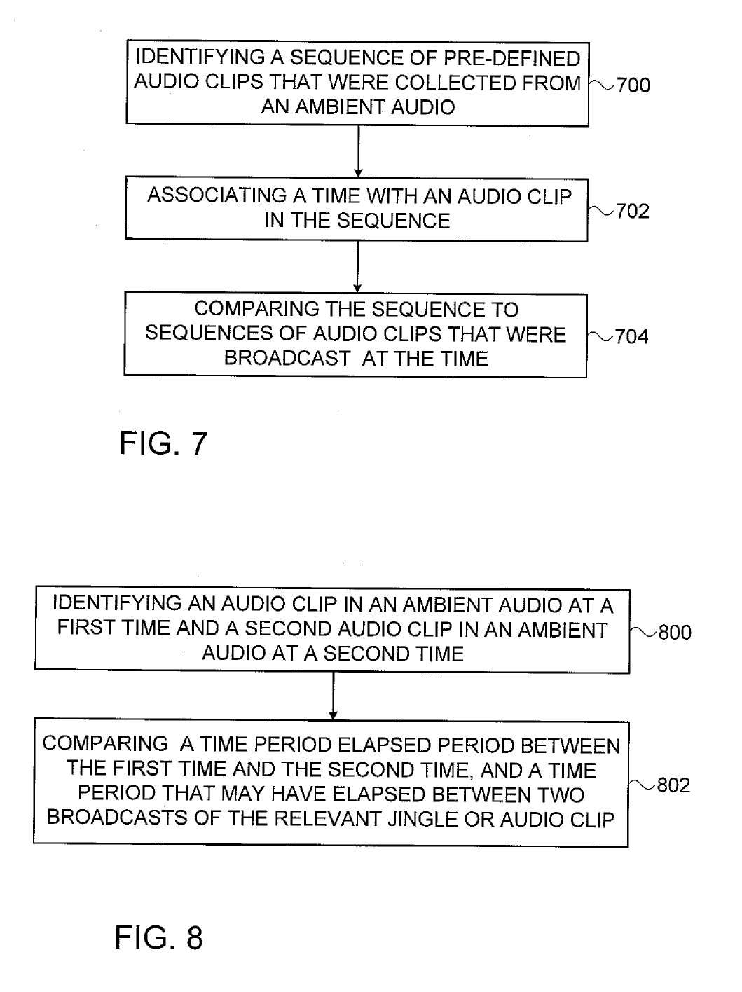

Reference is made to FIG. 8, a flow diagram of a method in accordance with an embodiment of the invention. Some embodiments may include a method for identifying a source of broadcast audio. In block 800, such method may include identifying a first audio clip in an ambient audio at a first time and a second audio clip in an ambient audio at a second time. In some embodiments, each of the clips may include for example a jingle of a radio station or other audio clip that is played only by a particular broadcaster. In block 802, a comparison may be made between a time period elapsed period between the first time and the second time, and a time period that may have elapsed between two broadcasts of the relevant jingle or audio clip. A mobile device may be assumed to have been in an area of the ambient audio wherein the jingles or audio clips were heard or collected, for the time period between the first time and the second time.

In some embodiments, a digital characteristic of the first audio clip and the second audio clip may be stored on a mobile device

In some embodiments, a characteristic of one or more audio clips that are associated with a broadcaster may be stored on a mobile device. In some embodiments, a frequency of a broadcast by a particular broadcaster during a particular period of one or more clips may be stored. For example, a broadcaster may play a jingle four times an hour, and may play an introduction of a news clip once an hour. Such frequencies may be stored in a mobile device.

While the invention has been described with respect to a limited number of embodiments, it will be appreciated that many variations, modifications and other applications of the invention may be made.

I claim:

1. A method for identifying a source of broadcast audio, comprising:
identifying a sequence of pre-defined audio clips, said audio clips collected from ambient audio;
associating a time of said collection with said identified sequence; and
comparing said identified sequence to a sequence of audio clips broadcast by a broadcast source, said broadcast at said time of said collection.

2. The method as in claim 1, comprising storing a characteristic of each of said pre-defined audio clips, and wherein said identifying comprises comparing a characteristic of said collected ambient audio with said stored characteristic.

3. The method as in claim 1, comprising transmitting said characteristic of each of said pre-defined audio clips to a mobile device, said mobile device suitable to perform said collection of ambient audio.

4. The method as in claim 3, comprising transmitting a digital representation of said identified sequence to processor associated with a memory said memory storing a digital representation of a plurality of sequences of audio clips broadcast by a plurality of broadcasters at said time.

5. The method as in claim 3, comprising determining a frequency of a broadcast by said broadcaster of an audio clip of said pre-defined audio clips, and selecting said pre-defined clips for said transmitting by a ranking of said frequency.

6. The method as in claim 1, wherein said comparing comprises comparing a digital representation of said identified sequence with a representation of a sequences of audio clips broadcast by a plurality of broadcasters at said time.

7. The method as in claim 1, comprising determining a probability that a source of said identified sequence is said sequence of audio clips broadcast by said broadcaster.

8. The method as in claim 1,
wherein said identifying a sequence comprises identifying a first sequence of pre-defined audio clips, from an indication of said audio clips collected in from ambient audio by a mobile communication device; and
wherein said time comprises a first time, and wherein associating a time comprises associating a first time; and
wherein said comparing said identified sequence comprises comparing said first identified sequence; and
comprising:
identifying a second sequence of pre-defined audio clips, said audio clips collected from ambient audio at a second time by said mobile communication device; and
comparing said second identified sequence to a second sequence of audio clips broadcast by said broadcast source, said broadcast of said second sequence at said second time; and
associating said mobile device with said broadcast source for a period between said first time and said second time.

9. A method for identifying a source of broadcast audio, the method comprising:
identifying a first audio clip in an audio at a first time and a second audio clip in an audio at a second time, said first audio clip and said second audio clip associated with a broadcaster; and
comparing an elapsed period between said first time and said second time to a pre-defined period.

10. The method as in claim 9, comprising
storing on a mobile device a digital characteristic of said first audio clip and said second audio clip;
collecting from a microphone associated with said mobile device said audio at each of said first time and said second time; and
comparing data of said first audio clip to said stored digital characteristic of said first audio clip.

11. The method as in claim 9, comprising storing a characteristic of each a plurality of audio clips associated with said broadcaster.

12. The method as in claim 9, comprising storing a frequency of a broadcast of each of said first audio clip and said second audio clip during a period that includes said first time and said second time.

13. A system for identifying broadcast audio content, said system comprising:
a processor to:
accept an indication of a first sequence of audio clips, said indication resulting from a comparison of pre-defined audio clips to audio clips collected in ambient audio;
accept a time associated with an audio clip of said first sequence of audio clips; and
compare said first sequence of audio clips to an indication of a plurality of audio clips as were broadcast during said time.

14. The system as claim 13 wherein said processor is a first processor, and comprising a microphone associated with a second processor, wherein said microphone is suitable to collect an indication of audio clips in ambient audio; and wherein said first processor is suitable to associate said ambient audio at said time with second processor.

15. The system as in claim 14, wherein said second processor is associated with a memory, said memory to store an indication of an audio clips of said pre-defined audio clips.

16. The system as in claim 13, wherein said processor is a first processor, and comprising a second processor to compare said pre-defined audio clips to audio clips collected in ambient audio.

17. The system as in claim 13, wherein said processor is suitable to calculate a probability that said first sequence of audio clips is a sequence of said plurality of audio clips as were broadcast during said time.
